(19) United States
(12) Patent Application Publication
(10) Pub. No.: US 2010/0317117 A1
(43) Pub. Date: Dec. 16, 2010

(54) SELECTIVE MEMBRANE EXTRACTION OF RADIOACTIVE ANALYTES

(75) Inventor: Dominic S. Peterson, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: LOS ALAMOS NATIONAL SECURITY, LLC, Los Alamos, NM (US)

(21) Appl. No.: 12/485,822

(22) Filed: Jun. 16, 2009

(51) Int. Cl. G01N 23/00

(52) U.S. Cl. 436/57

(57) ABSTRACT

A membrane selectively extracted a radioactive analyte from a sample solution. The membrane was prepared as thin film, and includes a soluble extractant and a collodion matrix that disperse the extractant homogeneously throughout the membrane. A membrane was formed by applying a solution including collodion, an extractant, and an organic solvent onto a surface of an aqueous solution containing a radioactive analyte. After the membrane formed on the surface, it was removed and then analyzed. The analysis proved that the membrane extracted radioactive analyte from the solution in far greater amounts compared to a control membrane prepared without the extractant.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates to radioactive analyte extraction and to membranes for selective extraction of radioactive analytes.

### BACKGROUND OF THE INVENTION

The analysis of radioactive analytes is important in a variety of areas including environmental protection, waste management, and bioassay. Surbeck for example, in “Alpha Spectrometry Sample Preparation Using Selectively Adsorbing Thin Films,” Applied Radiation and Isotopes, vol. 53, (2000), pp. 97-100, incorporated by reference, reported a selective adsorption of uranium-238 on a thin film prepared by fixing a fine powder of a cation exchanging resin known as DIPEX® (EICHROM TECHNOLOGIES) to a flat substrate with a binder. DIPEX® has been reported to separate Am from Pu because the resin has a different selectivity for these different analytes. Surbeck reported the selectivity can be adjusted by controlling the pH and chemistry of the eluent solution.

Radioactive analytes that emit alpha particles can be particularly difficult to deal with because fragments produced with alpha particles can contaminate the analysis system and degrade the signal from the detector. Inn et al. in “Use of Thin Collodion Films to Prevent Recoil-Ion Contamination of Alpha-Spectrometry Detectors,” Journal of Radioanalytical and Nuclear Chemistry, vol. 276, no. 2, (2008), pp. 385-390) reported that a thin film of collodion placed over the surface of an alpha source is transparent to alpha particles but prevents recoil ions from reaching the detector. These films do not affect the activity of the alpha source, and introduce minimal band broadening to the energy spectra obtained from the alpha particles.

### SUMMARY OF THE INVENTION

In accordance with the purposes of the present invention, as embodied and broadly described herein, the present invention includes a membrane for selective separation of radioactive analytes. The membrane is a thin film that selectively adsorbs radioactive analytes from a sample and is transparent to alpha particles. The membrane includes an extractant suspended in a collodion matrix, the extractant extracts radioactive analytes from a sample, the collodion matrix being transparent to alpha particles and homogeneously disperses the extractant throughout the membrane and traps fragments emitted from radioactive analytes that have already been extracted from the sample.

The invention is also concerned with a method for preparing a transparent membrane that selectively adsorbs radioactive analytes from a sample. The method involves preparing a solution of collodion, an extractant ligand, and organic solvent, the extractant ligand capable of selectively extracting a radioactive analyte from sample. The solution is applied to a surface of an aqueous liquid such as an aqueous solution or water. The membrane forms on the liquid surface as the organic solvent evaporates.

### DETAILED DESCRIPTION

The invention is concerned with extracting radioactive analytes from a sample. An aspect of the invention is a membrane that extracts radioactive analytes. Another aspect of the invention is a method for preparing such a membrane.

A membrane of this invention is particularly useful for analysis of alpha emitters because the membrane not only extracts the alpha emitter from a sample but also traps fragments (i.e. recoil ions) that are produced during alpha emission. By trapping these fragments, they are prevented from contaminating alpha detectors and detection chambers.

An embodiment membrane of the invention includes an extractant homogeneously dispersed in a matrix of collodion. An embodiment preparation includes forming a solution of flexible collodion (i.e. nitrocellulose) in alcohol and ether, then mixing the solution with isoamyl acetate, and then placing the resulting solution on a surface of water or aqueous solution. The membrane forms on the surface after the organic solvents (i.e. the alcohol, ether, and isoamyl acetate) evaporate.

The extractive ligand portion of the membrane extracts radioactive analytes from a sample solution. The selectivity depends on the chemistry of the analyte solution (its pH, for example). The collodion portion of the membrane provides support for the extractant. The collodion membrane allows alpha particles to pass through and prevents fragments from escaping as the extracted species emits alpha radiation.

There are benefits to using a membrane having both collodion and an extractant to collect radioactive analytes from solution and prepare them for analysis by radioactive spectrometric methods such as alpha spectrometry. For example, sample preparation is relatively quick and results in a reduced amount of waste compared to a column extraction, and also provides for a selective extraction of certain analytes from the analysis solution in the presence of additional ionic species. The collodion matrix acts like a filter that traps recoil ions but allows alpha particles to pass. A contaminating analyte could be collected on one side of the membrane, and then analyzed on the other side, which eliminates the possibility of contaminating the detector. Alternatively, sample collection could take place on both sides of the membrane followed by analysis. Because the membrane is transparent to alpha particles, a detection chamber could be constructed with two detectors, one at each face of the membrane. This configuration would enable the detection of alpha particles being emitted in nearly every direction, thus increasing the efficiency of detection.

A membrane of this invention can be used for analysis of unknown waste, for bioassay, for environmental monitoring, and for military applications. The membranes can be applied to surfaces, suspended in an open architecture, or used as a filter or in a filter-type structure.

Analysis of a radioactive liquid sample by radioactive spectroscopy often involves separating each analyte from solution by wet chemical methods. In this invention, an extractive resin is incorporated into a flexible collodion matrix to form a membrane that can then selectively extract analytes from solution. The extractive membrane is thin enough to allow alpha particles to pass through, which allows the membrane to be analyzed from either side or from both sides at the same time, increasing the efficiency of detection and potentially decreasing the amount of time required for analysis. The analyte can be collected on one side of the extractive membrane, or on both sides thereby increasing the amount of analyte that can be analyzed by a single membrane, increasing the speed of sample preparation and also reducing the amount of waste produced in analyzing radioactive analytes.

Extractants used with membranes of this invention include commercially available extractants such as DAAP (Dipentyl pentylphosphonate), DIPEX (P,P′-di(2-ethylhexyl)methanediphosphonic acid), CMPO (octylphenyl-N,N-di-isobutyl carbamoylphosphine oxide), DGA (N,N,N′N′-tetrakis-2-ethylhexyldiglycolamide), or TEVA, which are available from EICHROM Technologies. These extractants have been developed over the past 20 years by Horwitz et al. The variety of extractants for actinides is very broad and may include ligands for solvent extraction (i.e. crown ethers), ion exchange ligands (i.e. organophosphorous, diphosphonic, or diamide ion exchange ligands), polycarboxylates, synthetic derivatives of siderophores, or substituted N donors. Plutonium (“Pu”) selective extractants, for example, can be used with this invention. Such extractants for selective extraction of Pu have been reviewed by O'Boyle et. al in “A Review of Plutonium(IV) Selective Ligands,” Applied Radiation and Isotopes, Volume 48, Number 2, 1997, pp. 183-200, incorporated by reference herein; extractants are referred to as ligands by O'Boyle et al.

The wide variety of possible extractants for use with this invention allows different selectivities to be exploited depending on the analyte of interest and the specifics of the analysis solution. In a preferred embodiment, the extractant is combined with a solution of flexible collodion in alcohol and ether. Small amounts of camphor and castor oil also may be included in the solution. The collodion solution is diluted with another organic solvent, such as isoamyl acetate, and combined with the extractant. The membrane is formed by simply placing one to several drops of the resultant collodion/extractant solution onto the surface of an aqueous solution or water. As the organic solvent evaporates, the membrane forms on the aqueous liquid that remains.

It is useful to have a solid support such as a wire ring or a metal o-ring that the membrane will form on. This solid support provides mechanical stability when it is removed from the aqueous solution. A solid support also enables a greater variety of sampling approaches.

The formation of the membrane can be controlled by adjusting the viscosity of the solution by adjusting the concentrations of collodion and organic solvent, and by choosing solvents with different rates of evaporation.

Once the extractant membrane is formed, it can be utilized in different ways. In an embodiment, the extractant membrane is placed on a solid surface and then introduced into an analysis solution. In an embodiment, the extractant membrane is formed on an o-ring. In this embodiment, sample is collected on both sides of the membrane. In another embodiment, the extractant membrane is used in a filter-type setup.

A non-limiting list of possible radioactive analytes that can be analyzed using a membrane of this invention include ions of the following: Po-209, Po-210, Th-229, Th-230, U-233, U-234, U-235, U-238, Np-237, Pu-238, Pu-239, Pu-240, Pu-242, Pu-244, Am-241, AM-243, Cm-243, Cm-244, Cm-245

Once the radioactive analyte has been collected on the membrane, it can be analyzed in a variety of ways. In an embodiment, analysis of the side of the membrane not exposed to the analyte is used to minimize contamination of the radiation detector and detection chamber by recoil ions. In an embodiment, two detectors are used to analyze the membrane from both sides simultaneously, which increases sensitivity and efficiency and decreases time of analysis.

The valence of radionuclides present in the analysis solution can be adjusted to obtain optimal extraction as needed. The exact parameters utilized to extract radionuclides of interest onto the membrane will depend partially on the analyte of interest, the chemistry of the analysis solution, and the extractant used in the membrane. The extractive properties of the membrane can be controlled by the extractant present in the membrane, a combination of extractants, and by the concentration of the extractant in the membrane.

The following EXAMPLES provide non-limiting embodiments of extractive membranes of this invention and demonstrate how they are used for extracting radioactive analytes.

### Example 1

Five milliliters (“ml”) of isoamyl acetate (ACROS CHEMICALS) and flexible collodion solution (MALLINCKRODT CHEMICALS) were combined in a 20 ml vial. The exact composition of the flexible collodion solution was not known. The resulting solution contains approximately 4.4 grams of isoamyl alcohol and 3.8 grams of flexible collodion. An extractant solution was formed by adding 0.14 g of Dipex® resin (EICHROM TECHNOLOGIES). A membrane formed from this mixture has 4-20% extractant (i.e. Dipex® resin) by weight, depending on the exact composition of the flexible collodion.

A 50/50 v/v flexible collodion solution without an extractive resin was also prepared as a control membrane for comparison to the extractant membrane containing the Dipex® resin.

The extractant membrane and control membrane were formed using the extractant solution and membrane solution, respectively, and the membranes were tested using a primary dilution of a radioactive solution known as NIST SRM 4332C. This radioactive solution had an activity of 51 pCi/ml of Am-243 in 1M HNO₃. In each of four small Petri dishes, 7 ml of the primary solution were added. A wire ring was placed into each dish. Then, 15 drops of the flexible collodion solution were added. Dishes 1 and 2 contained the solution without the extractant. Dishes 3 and 4 included the Dipex® extractant. Dishes 1 and 2 are for membranes 1 and 2, respectively. Dishes 3 and 4 are for membranes 3 and 4, respectively. The solutions were allowed to stand for about 17 hours to let the membranes develop and allow sufficient contact time to let the extractant collect the radioactive analyte.

After the membranes formed, they were separated from the edges of the Petri dishes using a scalpel. Once the membranes were separated onto wire supports, they were placed onto planchettes (i.e. round plates that can be placed directly into an alpha spectrometer). In order to hold a membrane on a planchette, an o-ring was placed on top of the membrane.

In order to study the effect of analyzing the membrane from each side, membranes 1 and 3 were placed so that the side that contacted the analyte solution was face down. Membranes 2 and 4 were placed so that the side in contact with the analyte solution was face up. Once the membranes were on the planchettes, they were placed into alpha detectors and were counted for 12 hours. The long count time was to obtain counts for control membranes 1 and 2. The data now follows. The peak counts of Am-243 for the blank membranes were very low, about 16 counts for membrane 1 (solution side down) and 9 counts for membrane 2 (solution side up). The gross counts for membranes 1 and 2 were 103 and 43 counts, respectively. The number of counts for the membranes containing the extractant was much higher. Membrane 3 (solution side down) had Am-243 peak counts of approximately 580 counts. Membrane 4 (solution side up) had peak counts of approximately 710 counts. The gross counts for membranes 3 and 4 were 5724 counts and 7223 counts, respectively. There was significant scattering observed for all membranes. If a larger window were used, a much larger amount of counts would have been detected. The dispersion is likely due to the large amount of collodion solution used. A thinner collodion membrane likely would have resulted in better resolution. This is supported by an increased dispersion observed when the membrane was analyzed with the solution side down compared to the solution side up.

This EXAMPLE demonstrates the utility of using a membrane of this invention to extract radioactive analytes from solution for analysis by alpha spectrometry. The ability to analyze the membranes from either side has been demonstrated.

### Example 2

A collodion solution containing Dipex® resin was prepared as described in EXAMPLE 1. Also prepared was a control solution from flexible collodion solution without an extractant. Three extractant membranes and three control membranes were prepared on deionized water not containing any radioactive analyte. To form the membrane, an o-ring was positioned on the surface of a solution, after which 1-5 drops of the collodion solution was added. After waiting approximately 20 minutes, the o-ring was removed with the extractive membrane attached to the o-ring. This arrangement allows the membrane to have improved structural rigidity because the membrane is attached inside the loop of the o-ring and can be manipulated more easily by handling the o-ring than by handling the membrane directly.

To demonstrate the selective extraction of a radioactive analyte, 100 μl of a radioactive solution was placed on each membrane for 20 minutes. The solution was then removed and the membrane was rinsed with water. The membrane was allowed to dry and was then counted using alpha spectrometry for 90,000 seconds.

Three solutions were used to test the extractive properties of the membranes. The first (“solution 1”) was 0.1 M hydrochloric acid. The second solution (“solution 2”) was 4 M hydrochloric acid. The third solution (“solution 3”) was a solution of sodium nitrite in 0.1 M hydrochloric acid. All three solutions had approximately 50 pCi/ml of both ²⁴²Pu and ²⁴³ Am.

The control membranes (i.e. those without any extractive ligand) did not have any appreciable activity.

An extractant membrane extracted 73% of the ²⁴²Pu and 31% ²⁴³Am from the solution 1. The membrane extracted 21% of the ²⁴²Pu and 4% of the ²⁴³Am from solution 2. The membrane extracted 28% of the ²⁴²Pu 19% of the ²⁴³Am from solution 3.

This EXAMPLE demonstrates that the relative amount of plutonium extracted from solution compared to americium can be controlled by using different concentrations of acids and other additives such as the sodium nitrite. It should be possible to exercise an even greater amount of control over the extractive properties of a membrane of this invention depending on the choice of extractant used with the collodion matrix. This EXAMPLE also shows that using a solid support for the membrane increases their utility due to the increased structural rigidity provided by the solid support

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A transparent thin film that selectively adsorbs radioactive analytes from a sample, comprising:
a soluble extractant that selectively extracts radioactive analytes from a sample, and
a transparent collodion matrix that homogeneously disperses said extractant throughout the thin film and that traps fragments emitted from radioactive analytes that have already been extracted from the sample.

2. The transparent thin film of claim 1, wherein the transparent matrix is collodion.

3. The transparent thin film of claim 1, wherein the extractant is selected from crown ethers, organophosphorous ligands, diamides, picolinamides, diphosphonic ligands, polycarboxylates, hydroxamate ligands, octadentate complexing agents, catecholamides, linear hydroxypyridonates, substituted N donors and calixarene complexes.

4. The transparent thin film of claim 1, wherein the radioactive analyte is selected from radioactive ions that include an actinide, a lanthanide, or combination thereof.

5. The transparent thin film of claim 4, wherein the radioactive ions are selected from Po-209, Po-210, Th-229, Th-230, U-233, U-234, U-235, U-238, Np-237, Pu-238, Pu-239, Pu-240, Pu-242, Pu-244, Am-241, AM-243, Cm-243, Cm-244, Cm-245.

6. A method for preparing a transparent membrane that selectively adsorbs radioactive analytes from a sample, comprising:
preparing a solution comprising collodion, an extractant ligand, and organic solvent, the extractant ligand capable of selectively extracting a radioactive analyte from the sample,
applying the solution to a surface of a liquid comprising water,
allowing said organic solvent to evaporate, thereby forming the transparent membrane on the liquid surface.

7. The method of claim 6, further comprising removing the transparent membrane from the liquid surface.

8. The method of claim 6, wherein the extractant ligand is selected from crown ethers, organophosphorous ligands, diamides, picolinamides, diphosphonic ligands, polycarboxylates, hydroxamate ligands, octadentate complexing agents, catecholamides, linear hydroxypyridonates, substituted N donors and calixarene complexes.

9. The method of claim 6, wherein the organic solvent includes alcohol, ether, and isoamyl acetate.

10. The method of claim 6, wherein the liquid comprising water also comprises a radioactive analyte.
